(19) United States
(12) Patent Application Publication
(10) Pub. No.: US 2011/0054934 A1
(43) Pub. Date: Mar. 3, 2011

(54) PATIENT INITIATED EMERGENCY RESPONSE COORDINATOR SYSTEMS, APPARATUS, ARTICLES OF MANUFACTURE, AND METHODS

(75) Inventor: Guy Robert Vesto, Kildeer, IL (US)

(73) Assignee: General Electric Company, A New York Corporation, Schenectady, NY (US)

(21) Appl. No.: 12/551,224

(22) Filed: Aug. 31, 2009

(51) Int. Cl. G06Q 50/00

(52) U.S. Cl. 705/3; 705/2

(57) ABSTRACT

An example emergency response coordination apparatus includes a memory to store at least patient information, symptom knowledge base information, and care provider information. The apparatus includes a first communication interface to receive symptom information from a patient to be stored in the memory. The apparatus includes a processor to process the received symptom information based on stored patient information, symptom knowledge base information, and care provider information to determine a recommended care plan for the patient and to identify a care provider suitable to treat the patient's symptoms. The apparatus includes a timer to track elapsed time beginning with receipt of symptom information to aid in determining a time window for patient treatment. The apparatus includes a second communication interface to generate an output of the recommended care plan for the patient and directions to the care provider suitable to treat the patient's symptoms.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

The present disclosure generally relates to patient emergency response coordination. More particularly, the present disclosure relates to methods, apparatus, articles of manufacture, and systems to assist in customized, dynamic emergency response coordination for a patient via a mobile platform.

Healthcare practice has become centered around electronic data and records management. Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information for a particular information system may be centrally stored or divided at a plurality of locations. Healthcare practitioners may desire to access and/or distribute patient information or other information at various points in a healthcare workflow.

Additionally, if a medical emergency occurs (e.g. a car accident, heart attack, stroke, broken bone, etc.), quick action can be important to save lives and reduce permanent injury. If an ill or injured person and/or others with that person cannot obtain up-to-date care information rapidly, the lack of information can cause problems for effective treatment of the individual and potentially endanger the individual and/or delay treatment.

Currently, healthcare provider contact information can be provided by storing the information in one's personal digital assistant (PDA) and/or phone, for example. Alternatively, a person can refer to the Yellow pages and/or some other directory look up. Additionally, one can retrieve information online using the Internet. Further, a global positioning system (GPS) may include stored information.

However, each of the above mentioned sources has limitations. For example, PDA/phone information can become outdated after sometime, if not updated regularly. Further, the information may not be relevant to providers outside of a user's typical geographic area. Yellow pages information can also become outdated, and it can be difficult to find a Yellow pages book around in case of an emergency. Similarly, an Internet connection may not be available everywhere. GPS information can also become outdated depending upon when the software was updated. Additionally, GPS devices may not give comprehensive information on healthcare provider resources and capability.

Patients suffering a stroke, for example, must receive thrombolytic therapy (e.g., clot bursting drugs such as tissue plasminogen activator (TPA)) within a three-hour window. If the drug is administered, the rate of survival is greatly increased and the patient may fully recover. However, there are a number of obstacles along the way. The patient will likely hesitate and not seek immediate treatment. Second, the transportation time to a facility equipped to administer the drug and do the required computed tomography (CT) scan may be too long. The care providers at the stroke center must know the patient's medical history, especially allergies, medications and previous problems. Time is also wasted at the stroke center collecting insurance information and on admissions.

Many good hospitals are not Joint Commission on the Accreditation of Healthcare Organizations (JCAHO) accredited to provide stroke care and may not be willing or able to administer thrombolytic therapy at all. Currently, patients must hope that the EMS takes them to a hospital that will administer TPA. The American Heart Association currently recommends that patients at high risk to make an emergency plan which includes the nearest stroke center and to carry a list of allergies and medications. The plan is not effective if the patient is on vacation or even traveling within an urban area. Patients not at high risk would be unlikely to have such a plan at all.

### BRIEF SUMMARY

Certain examples provide methods, systems, apparatus, and/or articles of manufacture for patient emergency response coordination.

Certain examples provide an emergency response coordination apparatus. The apparatus includes a memory to store at least patient information, symptom knowledge base information, and care provider information. The apparatus also includes a first communication interface to receive symptom information from a patient to be stored in the memory. The apparatus further includes a processor to process the received symptom information based on stored patient information, symptom knowledge base information, and care provider information to determine a recommended care plan for the patient and to identify a care provider suitable to treat the patient's symptoms. Additionally, the apparatus includes a timer to track elapsed time beginning with receipt of symptom information to aid in determining a time window for patient treatment. The apparatus includes a second communication interface to generate an output of the recommended care plan for the patient and directions to the care provider suitable to treat the patient's symptoms.

Certain examples provide a tangible, computer-readable storage medium including executable program instructions stored on the medium that, when executed by a programmable system, implement an emergency response coordinator including a patient emergency portal to receive symptom information for a patient. The emergency response coordinator implemented by the executable program instructions also includes an emergency case service component to automatically and dynamically coordinate emergency response management for the patient. The emergency response coordinator includes, additionally, a state machine guiding processing of the received symptom information based on stored patient information, symptom knowledge base information, and care provider information to determine a recommended care plan for the patient and to identify, based on the recommended care plan and patient location information, at least one care provider suitable to treat the patient's symptoms. The emergency response coordinator further includes a timer to track elapsed time beginning with receipt of symptom information to aid in determining a time window for patient treatment. Additionally, the implemented emergency response coordinator includes a notification broker to generate an output of the recommended care plan for the patient and directions to the care provider suitable to treat the patient's symptoms.

Certain examples provide a method of patient-initiated emergency response coordination. The method includes receiving, via a mobile device, an activation of emergency response from a user. The method additionally includes generating, based on user medical history and symptom information, patient location information, and care provider information, directions to a nearest suitable care provider for the user and providing the directions to the user via the mobile device. The method also includes notifying the nearest suitable care provider of the condition of the patient and the patient's impending arrival The method further includes tracking elapsed time from the activation of the emergency response and providing the elapsed time to the care provider. In addition, the method includes outputting patient information to the care provider to facilitate patient admission and treatment.

### BRIEF DESCRIPTION OF SEVERAL VIEWS OF THE DRAWINGS

FIG. 1 illustrates an example of a window of time during which actions should occur to treat a stroke patient to help avoid further damage to the patient.

FIG. 2 illustrates an example mobile healthcare information communication system.

FIG. 3 illustrates a flow diagram for an example method for mobile collection of healthcare provider information.

FIG. 4 illustrates an example of a mobile healthcare information system.

FIG. 5 illustrates an example system and flow diagram for emergency response using an emergency response coordinator (ERC).

FIG. 6 illustrates an example emergency response coordination system.

FIG. 7 is a block diagram of an example processor system that can be used to implement systems, apparatus, articles of manufacture, and methods shown in FIGS. 1-6 and described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements is hereby expressly defined to include a tangible medium such as a memory, a digital video disc (DVD), compact disc (CD), etc. storing the software and/or firmware.

An Emergency Response Coordinator (ERC) is provided to automate emergency planning for patients at risk for one or more conditions. The ERC includes a listing of allergies, medications, and/or other important health-related information for the patient. The ERC provides up-to-date information regarding the patient and his or her surroundings, including the nearest treatment center to care for a particular condition suffered by the patient. The ERC can be effective when the patient is on vacation or traveling within an urban area to direct the patient to the most capable treatment center when there are multiple treatment centers available.

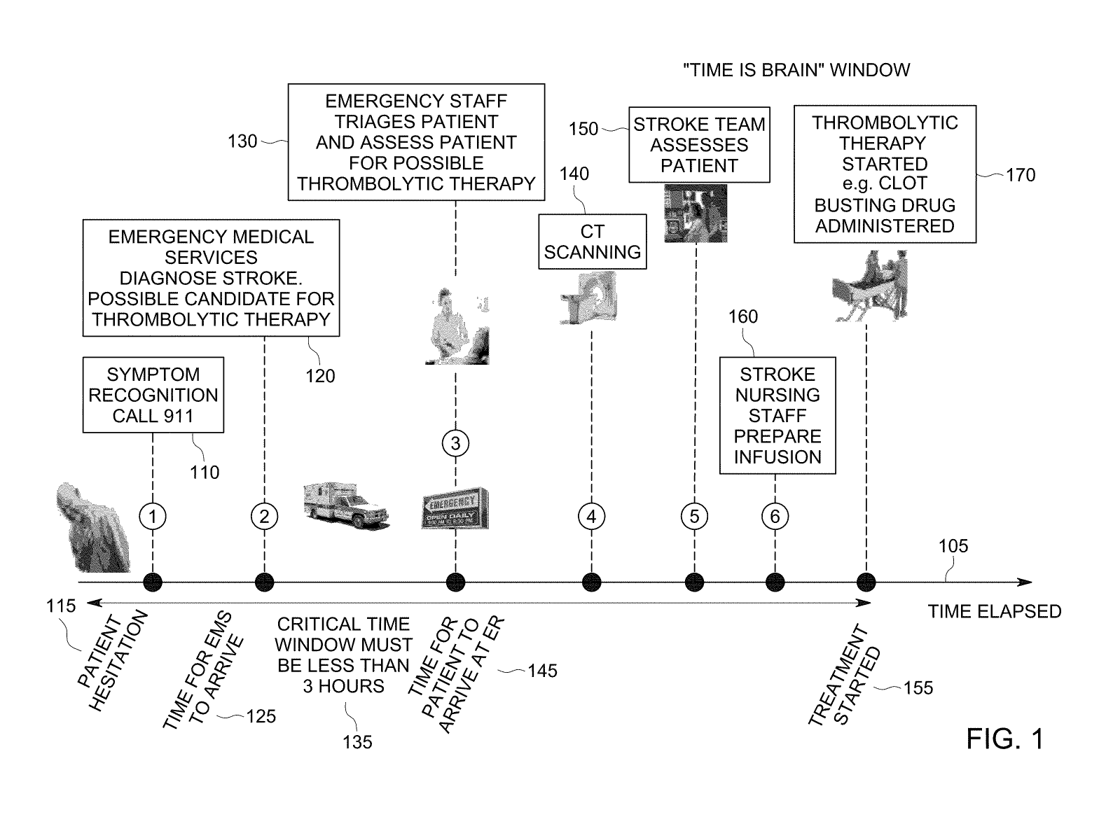

The ERC provides coordination and guidance services for users having one or more existing conditions that have previously undergone treatment. For example, the ERC can provide coordination and guidance services for stroke patients. As shown in FIG. 1, a stroke patient has a certain window of time within which action is important to help avoid further damage (e.g., permanent impairment or death) to the patient.

At block 110, upon symptom recognition, an emergency responder (e.g., a 911 operator) is contacted. At block 120, a stroke, for example, is diagnosed by emergency medical services. The stroke patient may be a possible candidate for thrombolytic therapy, for example. At block 130, emergency staff at a healthcare facility triages the patient and assesses the patient for thrombolytic therapy. At block 140, a scan (e.g., a CT scan) of the patient is obtained. At block 150, a stroke team assesses the patient. At block 160, stroke nursing staff prepare an infusion. At block 170, thrombolytic therapy begins (e.g., a clot-busting drug is administered to the patient).

FIG. 1 shows time elapsed 105 from the time that symptoms are recognized to the time of treatment. According to stroke treatment guidelines, for example, a time from symptom recognition to administering drug therapy must be less than three hours. Events, such as patient hesitation 115, a time for EMS personnel to arrive 125, a time for the patient to arrive at a treatment facility 135, and a time for treatment start 145, affect the time elapsed 105.

The ERC can be implemented as or in conjunction with a software service that serves as a coordinator and a companion for a stroke patient to guide the patient and the care providers through the time-critical window during which thrombolytic therapy must be delivered, for example. The ERC can also be adapted to be used for other types of emergency response, such as with epilepsy, diabetes, heart attack, etc. The ERC can utilize a phone, web browser, and/or other device to interact with the patient and health care providers. The ERC is especially useful for patients traveling in areas where electronic medical records and/or other patient information are not readily available. The ERC can help provide peace of mind to high risk patients and guidance through medical care during an emergency. The ERC can be configured to direct patients to the medical centers that can provide the highest quality of care in an area under the circumstances and can assist with admission and accessing medical records at remote sites. Relevant medical centers can be located based on Joint Commission on the Accreditation of Healthcare Organizations (JCAHO) certification, for example.

The ERC delivers information just-in-time (e.g., on demand, at least substantially in real time, etc.) to the patient and/or patient's helper. The ERC is accessible via phone, web browser, and/or other device capable of providing questions to and receive answer from a patient to, for example, confirm symptoms. Upon ERC initiation for a patient based on one or more symptoms, a timer is activated, and the ERC delivers a list of nearby treatment centers (e.g., stroke centers, clinics, hospitals, etc., having a capability to treat a particular patient condition) with directions to the facility. In some examples, emergency response can be called automatically if the symptom(s) justify such action. A list of treatment centers can indicate those centers that are JCAHO certified to provide certain care, such as stroke care. For example, in the case of stroke, hospitals that are not certified may not be willing to provide thrombolytic therapy.

In some examples, the ERC can retrieve a patient's electronic medical records including, for examples, medications, allergies, and/or a chart summary. A report for a patient can be sent both to the ERC device (e.g., a phone) and forwarded as an e-mail and/or other electronic message report to the center (e.g., the stroke center) where the patient is being directed by the ERC. Additionally, registration material, such as insurance information, patient address, etc., can be sent to the treatment center. If the center is part of a Health Information Exchange (HIE), the ERC can pre-admit the patient.

If an ambulance is dispatched, the ERC can serve as a valuable time tracking device and can direct emergency personnel, such as a paramedic or other emergency medical services (EMS) personnel, to the correct care center. At the care center, a triage nurse can use the phone, web browser, etc., of the ERC and have up-to-date information for the patient, patient history, symptoms, time lapsed, etc. The ERC can also notify a patient's primary care physician and emergency contact simultaneously (including at least substantially simultaneously due to lags, delays, variances, etc. in communication). The ERC can transmit follow-up messages to the patient to encourage and/or remind the patient to continue to seek treatment and to provide information on what treatment and testing to expect.

In some examples, the ERC is connected to a Health Information Exchange via industry standard formats and/or communications to increase interoperability with a variety of health information networks and infrastructures. The ERC delivers information to the patient's mobile phone and allows caregivers access to the patient's electronic medical record during emergency cases. The ERC provides authorization for the care provider to retrieve records via a web browser. Additionally, the ERC notifies the care provider of the admission and notifies an emergency contact. The ERC contains quality information on the stroke centers from JCAHO. The ERC provides time tracking information for the emergency care providers can improve response times in the future. The ERC also contains a knowledge base about conditions such as cardiovascular diseases and strokes. The patient can enter information through an Emergency Planner Tool, with information such as directives to care providers and instructions for emergency contacts or next of kin.

In some examples, the ERC can interface with a service such as Google® maps to locate a care center and provide directions and travel times from a current location to the care center. The ERC can include a state machine to track events during a time critical window for a condition, including a timer. The ERC can include a report generator to generate reports with information depending on the patient's current location and treatment center, etc. The ERC can utilize a global position system (GPS) and/or other tracking/navigational capability of the user's phone or other mobile device to locate the patient, for example.

In some examples, medical records can be summarized and downloaded directly to a user's phone and/or other portable electronic device by the ERC.

Some examples provide systems, apparatus, articles of manufacture, and methods to assist in automated collection and/or updating of healthcare provider information in a mobile or portable environment. For example, some examples help enable collection and/or updating of healthcare provider information when a person is driving and/or vacationing in an area.

Some examples help obtain accurate contact information for nearby healthcare providers when a user is traveling or moving among different locations. Currently, information loaded into a personal digital assistant (PDA) or phone can get stale if not updated regularly. Global positioning system (GPS) information can also become stale or outdated depending upon when its software was updated. Yellow pages information can also become stale and is additionally often difficult to find in case of emergency. Further, an Internet connection may not be available to allow a Web-based electronic retrieval of information.

In some examples, more up-to-date information can be provided wirelessly to a mobile device positioning within a certain distance of a transmitter. For example, suppose that Mr. John Doe is visiting San Diego with his family, and he has a mobile healthcare information receiver with him. The family does not otherwise have any information about nearby healthcare providers and their contact information. While the family is playing volleyball on the beach, Mr. Doe's son breaks his hand. In this case, it would be beneficial to have contact information for a nearby orthopedic clinic. Using the mobile device having a receiver, Mr. Doe can look up a nearby orthopedic clinic using information collected by the receiver while Mr. Doe was driving through the streets of San Diego. Healthcare providers, such as an orthopedic clinic, can continuously or periodically broadcast information within the area.

Some examples provide location-specific information with improved accuracy available on demand via a user's receiver. Some examples employ a push model rather than a pull model to dynamically obtain information regarding healthcare services in a given geographical area surrounding a receiving device. Some examples provide transmitters that continuously and/or periodically broadcast and update information in area receiver(s) so that user(s) within a certain area have more current information.

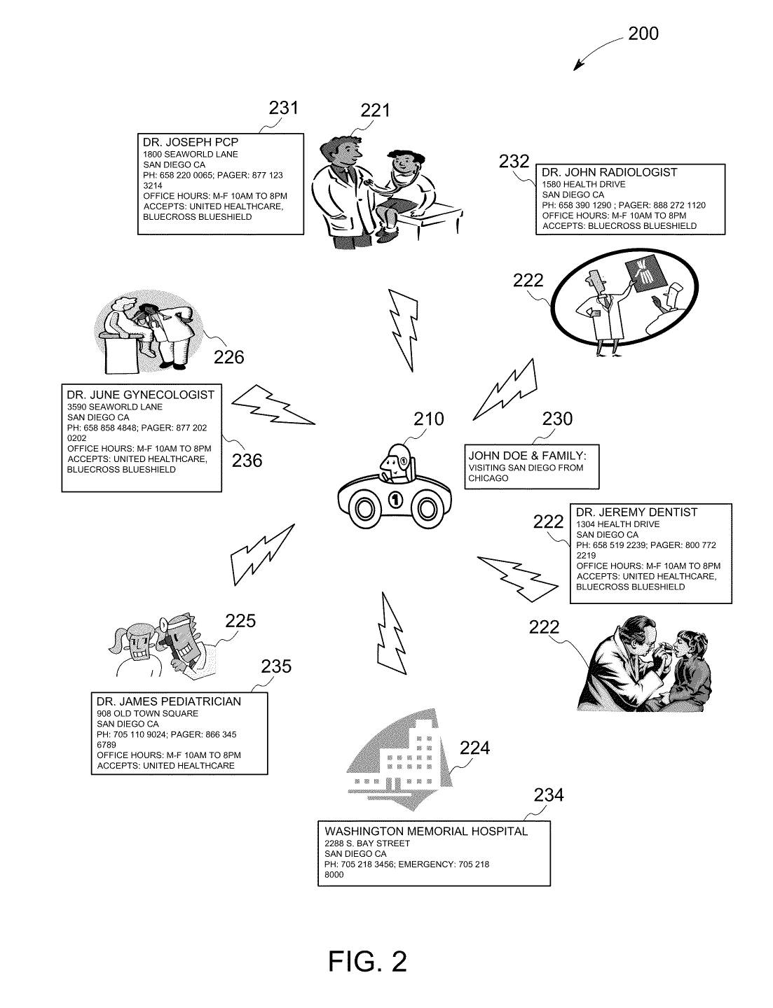

In some examples, a communication system includes a receiver and a transmitter communicating with each other via a network and/or other communication protocol. The receiver can be an independent device or can be integrated with another electronic system, such as a GPS, phone/PDA, and/or automobile computer system. The transmitter can be a device installed at each interested healthcare service provider location as shown in FIG. 2. The transmitter can be programmed to continuously and/or periodically broadcast contact information for the healthcare provider. Hence, whenever a vehicle/person passes within a certain area and has a receiver, the transmitted information will be received and stored or updated in the receiver for use.

The ERC can function in conjunction with a mobile healthcare information communication system, such as that described in U.S. patent application Ser. No. 12/189,399, assigned to General Electric Company and herein incorporated by reference in its entirety. FIG. 2 illustrates an example of a mobile healthcare information communication system 200. The system 200 includes a mobile healthcare information device 210 and a plurality of healthcare information transmitters 221-226. The plurality of healthcare information transmitters 221-226 provide contact information 231-236. In certain embodiments, the device 210 can provide information 230 as well. Information 230-236 can include provider name, provider address, provider phone number, provider facsimile number, provider pager number, provider office hours, provider insurance carrier information, etc. Information 230-236 can be transmitted from transmitters 221-226 using radio frequency transmission, cellular transmission, and/or other wireless communication, for example.

In some examples, the mobile healthcare information device 210 and healthcare information transmitter(s) 221-226 can be implemented alone or in combination of hardware, software, and/or firmware. In some examples, mobile healthcare information device 210 and/or healthcare information transmitter(s) 221-226 can include both transmitting and receiving hardware, software and/or firmware.

In some examples, the device 210 includes a memory, a processor, and a receiver for receiving information from at least transmitters 221-226 within range. The device 210 may also include a transmitter to provide information about the user and/or device 210 location back to the healthcare provider 221-226. In some examples, the memory can store user information, such as personal medical information and/or history, as well as information 231-236 received from provider(s) 221-226.

In some examples, the device 210 allows information display and may also allow information entry and/or modification. The device 210 includes a screen, such as an LCD or touchscreen, and may include an input device, such as a touchpad, touchscreen, keyboard, stylus, joystick, trackball, wheel, button, mouse and/or other input device. The device 210 may also include one or more speakers and/or microphones for audio output and/or input, for example. The device 210 may communicate with an external system via a wireless, wired, infrared, and/or other connection, for example.

In some examples, some or all of the personal information stored on the device 210 may be read without authorization. In some examples, no personal information stored on the device 210 may be read without authorization. The authorization may be made by, for example, the patient or a medical administrator. Examples of personal information that may be accessed without authorization may include: patient name, address, patient contact information, and a patient identifier.

Patient information may include, for example, one or more of the following pieces of information: patient name, patient address, patient contact information, emergency contact information, insurance information, billing information, primary care doctor information, specialist information, drug information, allergy information, current medication information, and a patient identifier. Patient information may also include patient records and reports. In addition, patient information may also include, for example, biographical information, medical history, family history, genetic test results, blood test results, heart rate, blood pressure, blood flow, and biomarker presence information. The patient identifier may be unique, for example, within a network or globally. Blood test results may include, for example, test results for blood oxygen level, white blood cell count, T-cell count, complete blood count, thyroid, cardiac risk factors, cholesterol, proteins, PSA (prostate), waste products, and glucose. In certain embodiments, patient information may come from multiple sources. For example, patient information may come from one or more of the patient, an insurance company, an in-network healthcare provider, and an out-of-network healthcare provider.

In operation, a user with the device 210 is traveling in an area having a plurality of healthcare providers. The plurality of healthcare providers use healthcare information transmitters 221-226 to broadcast information 230-236 regarding their healthcare services within the geographic area. The device 210 receives the information 230-236 broadcasts when the device is in the area. If a situation for medical assistance or consultation arises, the user can refer to the device 210 for information 230-236 regarding providers in the area.

For example, if a user's child becomes sick on vacation, the user can refer to the device 210 and determine that, based on the information 235 from the transmitter 225, Dr. James Pediatrician is located nearby at a certain address with certain office hours and accepts certain insurance. In some examples, the device 210 can initiate a communication, such as a phone call, to confirm availability and notify the provider of the user's impending arrival. In some examples, the information 235 can include website information which the user can view via the device 210.

As another example, if a user develops a toothache while traveling and wants the tooth checked for a cavity, the device 210 can be reviewed to identify contact information 233 for a dentist in the area.

The device 210 can be used to retrieve various other provider information including, for example, primary care physician information 231, radiologist information 232, hospital information 234, and gynecologist and/or other specialist information 236 broadcast from transmitters 221, 222, 224, 236 and received by the device 210 within a given radius or area of signal transmission.

Certain examples enable users to transfer at least certain medical history or and/or other personal medical information (PMI) from the device 210 to a retrieval device at a provider site. Transfer of personal medical information can save time, improve user experience, and improve accuracy of information, for example.

In an emergency scenario, certain examples can be used to retrieve all or part of a patient medical history from the device 210 and transfer the information into a scanning device at the provider to provide an emergency medical technician, clinician, and/or other medical staff/system with the information. In some examples, security measures, such as password and/or biometric authentication, can be built into the phone and/or retrieval device to help ensure that the individual's information was not transmitted inappropriately.

In some examples, the device 210 uses a configurable retention algorithm to determine which information 231-236 is stored in memory and for how long the information is stored. In some examples, grace periods can be configured to eliminate repeated loading and purging of information 231-236 from providers on an edge of an area range.

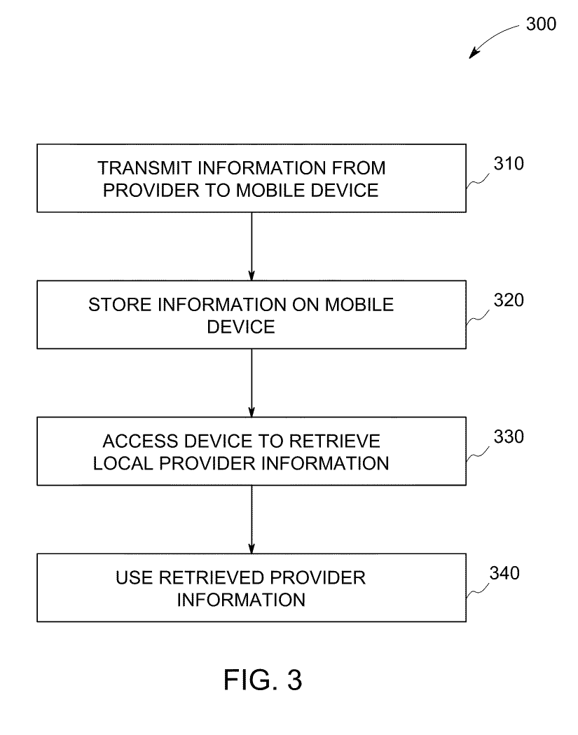

FIG. 3 illustrates a flow diagram for an example method 300 for mobile/portable collection of healthcare provider information. At block 310, information is transmitted from a healthcare provider to a mobile healthcare device within range of the provider. At block 320, the information is stored on the mobile healthcare device. At block 330, the device is accessed to retrieve local provider information. At block 340, retrieved provider information is used to contact and/or direct the user to a healthcare provider.

Referring back to FIG. 3 in more detail, at block 310, information is transmitted from a healthcare provider to a mobile healthcare device within range of the provider. For example, a healthcare provider can include a transmitter (and possibly receiver) device, such as radios, computers, wireless local area networks, etc., to facilitate wireless transmission of information regarding that provider and services offered by that provider. For example, a primary care physician can advertise that he or she is a primary care physician and include office location, directions, office hours, insurance information, services offered, etc. A mobile healthcare device within a certain range of the transmitter receives this information. In some examples, any such device within range can receive and understand the information. In some examples, only registered or otherwise authorized devices can receive and process the information.

At block 320, the information is stored on the mobile healthcare device. For example, a mobile healthcare device within a certain range of the transmitted information receives the information and stores the information temporarily or more permanently in a memory and/or other storage on the mobile healthcare device.

At block 330, the device is accessed to retrieve local provider information. For example, a user may interact with the device via touchscreen, keypad, scroll and/or clickwheel, voice command, etc., to retrieve information about local provider(s) within a certain range of the device. Information may be retrieved based on all provider(s) in the area and/or by provider(s) of a particular type in the area, for example. Provider information may be displayed on a screen with the device and/or may otherwise be output, such as via an audible response, for example.

At block 340, retrieved provider information is used to contact and/or direct the user to a healthcare provider. For example, a user may touch a spot on the screen, press a button, use a voice command, etc., to initiate a call with a provider, send a message to a provider, access a provider website and/or other information portal, etc. As an example, selecting a local pediatrician allows the user to initiate a phone call to that pediatrician via the device and/or a phone/radio in communication with the device (e.g., via WiFi, Bluetooth, and/or other wired or wireless communication protocol).

In some examples, the user can then exchange further information with the provider via the device.

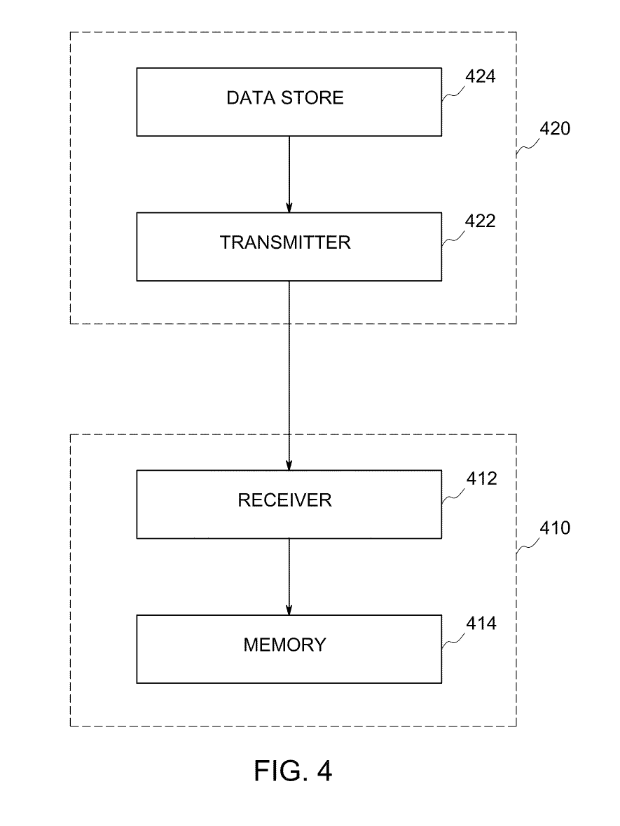

FIG. 4 illustrates an example of a mobile healthcare information system 400 used in emergency response and patient care. The system 400 can be used to implement the examples described above with respect to FIGS. 1-3, for example. The system 400 includes a user module 410 and a healthcare provider module 420. The user module 410 communicates with the healthcare provider module 420 to receive information from the healthcare provider module 420. The user module 410 may also transmit information back to the healthcare provider module 420, but in some cases the transmission of information may be one-way, from the module 420 to the module 410.

Information communicated between the user module 410 and the healthcare provider module 420 can include provider name, provider address, provider phone number, provider facsimile number, provider pager number, provider office hours, provider insurance carrier information, etc. Information can also include user name, user location, user medical history, etc. Information can be transmitted using radio frequency transmission, cellular transmission, and/or other wireless communication, for example. In some examples, data security, such as encryption, password protection, biometric authentication, and the like, can be used to protect some or all of the information being transmitted.

The user module 410 can, for example, include a receiver 412 and a memory 414. The receiver 412 can optionally include transmitter functionality to provide information back to the provider module 420. A processor (not shown) can be included in the receiver 412 and/or can be provided in the user module 410 in addition to the receiver 412 and memory 414. The memory 414 can store data such as information received from the provider module 420, user information, instructions/code for execution, etc.

The healthcare provider module 420 can, for example, include a transmitter 422 and a database or other storage 424. The transmitter 422 can optionally include receiver functionality to receive information for the user module 410. A processor (not shown) can be included in the transmitter 422 and/or can be provided in the healthcare provider module 420 in addition to the transmitter 422 and data store 424. The data store 424 can store data such as provider information, patient medical record information, scheduling information, instructions/code for execution, etc.

In some examples, the healthcare provider module 420 transmits provider information which is received by the user module 410 when the module 410 is within range of the module 420. In some examples, the healthcare provider module 420 can receive a response from the user module 310 when the user module 310 is within range and has received the provider information.

In some examples, the user module 410 allows information display and may also allow information entry and/or modification, for example. For example, the user module 410 can include a screen, such as an LCD or touchscreen, and can include an input device, such as a touchpad, touchscreen, keyboard, stylus, joystick, trackball, wheel, button, mouse and/or other input device. The user module 410 can also include one or more speakers and/or microphones for audio output and/or input, for example. The user module 410 can communicate with the healthcare provider module 420 via a wireless, wired, infrared, and/or other connection, for example. In some examples, the user module 410 can be incorporated into a cellular phone, personal digital assistant, handheld computer, laptop computer, radio, navigation system, other automobile computer system, etc.

In some examples, the healthcare provider module 420 can be connected to a workstation to allow display, retrieval, and manipulation of data stored in the data store 424. For example, the module 420 can be connected to a monitor and keyboard to allow provider information to be updated, schedules to be maintained, patient information to be reviewed, etc. For example, the module 420 can be incorporated in a healthcare information system, such as a PACS, RIS, EMR, etc.

In some examples, the user module 410 and the healthcare provider module 420 can be implemented using hardware, software, and/or firmware. In some examples, the user module 410 can pull information from the provider module 420. In some examples, the provider module 420 can push information to the user module 410.

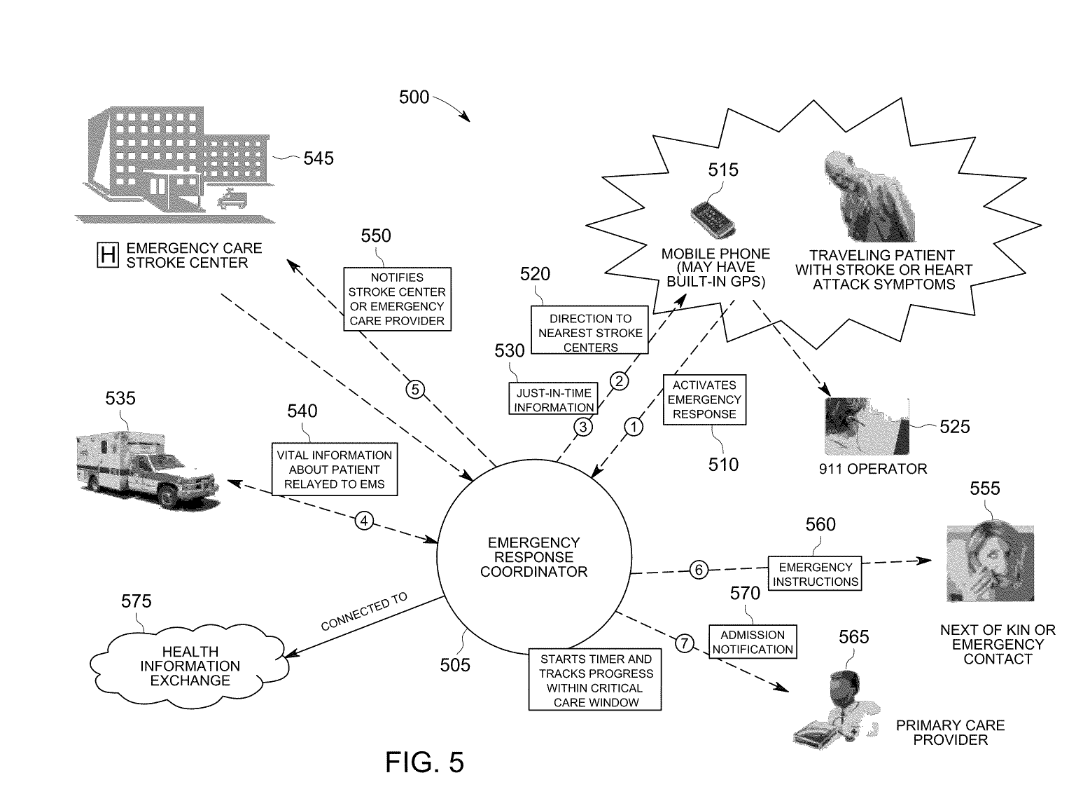

FIG. 5 illustrates an example system and flow diagram 500 for emergency response using an emergency response coordinator (ERC) 505. A mobile device 515 (e.g., a mobile phone including a locator (e.g., a global positioning system) and/or other sensor (e.g., a heart monitor, blood pressure monitor, etc.)) activates an emergency response 510 at the ERC 505 in response to one or more detected patient symptoms. The mobile device 515 can also be used to contact an emergency operator (e.g., 911 operator), for example. Symptoms can be automatically detected by the mobile device 515 and/or input by the user via the mobile device 515. Symptoms can indicate the patient is experiencing a heart attack or stroke, for example.

The ERC 505 provides directions to a nearest care center 520 and just-in-time information 530 to the mobile device 515. For example, as described above, the mobile device 515 can be used to direct the patient and/or others with the patient to a nearby facility having the appropriate capabilities to treat the patient's condition. Direction can include, for example, map(s), video, audio, text, and/or other instruction to guide the patient to a treatment facility.

The ERC 505 can communicate with emergency response or other medical personnel 535 (such as an ambulance and/or other EMS) to relay vital information about the patient 540. The ERC 505 can notify 550 an emergency care or other provider 545, such as a stroke treatment center, regarding the patient and the patient's symptoms. The treatment center 545 or provider can transmit information back to the ERC 505 to coordinate patient care, transportation, etc.

The ERC 505 can also be used to notify an emergency contact 555 (e.g., next of kin, spouse, neighbor, etc.) and provide emergency instructions 560 to the contact 555 regarding the patient. The contact can be alerted as to the patient's condition and destination for treatment 545, for example. The ERC 505 can also notify the patient's primary care provider 565 to provide patient admission notification 560 and/or other information, for example. In some examples, a patient and/or bystander can initiate a teleconsultation with trained medical personnel in the event emergency personnel have not yet arrived at the scene.

The ERC 505 can include a timer that begins upon receipt of emergency information from the mobile device 515 and tracks progress toward patient care within a critical care window or time period. The ERC 505 can communicate with a health information exchange (HIE) 575 to retrieve and/or transmit electronic patient information, diagnosis/treatment information, treatment center information, etc. In some examples, the ERC 505 stores an audit log of care information and/or other instructions provided for the patient's care.

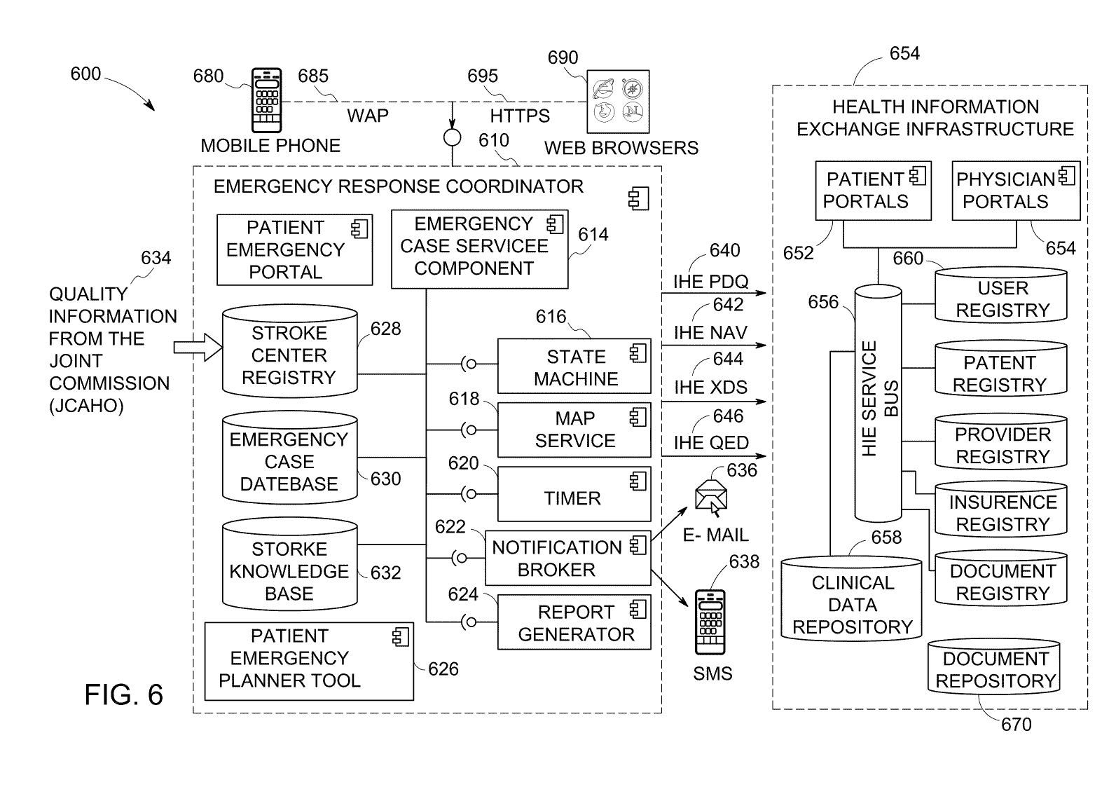

FIG. 6 illustrates an example emergency response coordination system 600 including an emergency response coordinator (ERC) 610, a health information exchange (HIE) infrastructure 650, a mobile device 680, and a Web interface 690. The ERC 610 includes a patient emergency portal 612, an emergency case service component 614, a state machine 616, a map service 618, a timer 620, a notification broker 622, a report generator 624, a patient emergency planner tool 626, a treatment center registry 628, an emergency case database 630, and a knowledge base 632, for example. The HIE infrastructure 650 includes one or more patient portals 652, one or more physician portals 654, an HIE service bus 656, a clinical data repository 658, a user registry 660, a patient registry 662, a provider registry 664, an insurance registry 666, a document registry 668, and a document repository 670, for example.

The ERC 610 communicates with the HIE infrastructure 650 as well as with one or more mobile devices 680, Web interfaces 690, etc. The ERC 610 communicates with the mobile device 680 (e.g., a mobile phone, personal digital assistant, smart phone, handheld computer, etc.) via a wireless application protocol (WAP) 685, for example. The ERC 610 communicates with the Web interface 690 (e.g., a Web browser) via a secure hypertext transfer protocol (HTTPS) 695, for example. Information can be exchanged between and/or among the ERC 610 and the one or more mobile device(s) 680, Web interface(s) 690, and the like.

The ERC 610 exchanges data with the HIE infrastructure 650 via one or more Integrating the Healthcare Enterprise (IHE) profiles and/or frameworks, such as IHE Patient Demographics Query (PDQ) 640, IHE Notification of Document Availability (NAV) 642, IHE Cross Enterprise Document Sharing (XDS) 644, and/or IHE Query for Existing Data (QED) 646, etc.

The HIE infrastructure 650 includes a plurality of components including, for example, one or more patient portals 652, one or more physician portals 654, a clinical data repository 658, a user registry 660, a patient registry 662, a provider registry 664, an insurance registry 666, a document registry 668, and/or a document repository 670 connected via an HIE service bus 656. Using one or more of the patient and/or physician portals 652, 654 information from the plurality of data sources 658, 660, 662, 664, 666, 668, 670 can be retrieved, stored, and/or updated. IHE profiles 640, 642, 644, 646 can be employed to provide information from the ERC 610 to the HIE infrastructure 650 and/or provide information from the HIE infrastructure 650 to the ERC 610, for example.

The ERC 610 includes a plurality of components including, for example, a patient emergency portal 612, an emergency case service component 614, a state machine 616, a map service 618, a timer 620, a notification broker 622, a report generator 624, a patient emergency planner tool 626, a care center registry 628, an emergency case database 630, and/or a knowledge base 632.

Within the ERC 610, a patient can input information and/or initiate action via the patient information portal 612. The patient information portal 612 can be accessed via the mobile device 680 and/or the Web interface 690, for example. In some examples, the ERC 610 can be implemented and/or embedded in the mobile device 680. The emergency case service component 614 drives actions of the ERC 610 based on information, such as observed symptoms, medical history, location, available resources, etc., gathered from the patient and/or other user, database information, knowledge base information, etc. The state machine 616 drives operation of the ERC 610 through a plurality of steps and/or states from receiving and/or detecting patient symptom information to patient treatment. The state machine 616 can be implemented as, for example, a business rules engine, a process manager, a workflow engine, a complex event processing system, and/or other engine, etc. (hereinafter referred to as a state machine). The timer 620 tracks a period of time elapsed for comparison to an ideal and/or acceptable window of time for condition treatment and/or other diagnosis and/or treatment purposes. The map service 618 provides route and/or other guidance information to guide emergency response personnel to a location of the patient and/or provide the patient with information regarding a nearest acceptable care facility, for example.

The care center registry 628 can receive information from an external source such as quality information from the Joint Commission (JCAHO) 634. The care center registry 628, emergency case database 630, and/or knowledge base 632 provide information to assist in operation and/or determination of the other components of the ERC 610 and/or to provide information to a user of the ERC 610 (e.g., the patient), emergency response personnel, and/or other care provider, for example. The notification broker 622 provides external communication such as e-mail 636 and/or short message service (SMS) 638 message to notify a next of kin, emergency contact, emergency responder, electronic medical record service, etc. The report generator 624 can be used to compile and/or otherwise generate electronic reports for transmission to a care center, electronic medical record, HIE 650, etc.

The patient emergency planner tool 626 can be used to generate a plan of care and/or other plan of action based on patient symptoms, patient history, patient location, nearby care center(s), knowledge base and/or other historical information, etc. In some examples, the emergency planner tool 626 can drive and/or affect operation of the emergency case service component 614 and, in turn, affect operation of other components of the ERC 610. In some examples, the emergency planner tool 626 is accessible for user input, information retrieval, and/or modification via the mobile device 680 and/or Web interface 690.

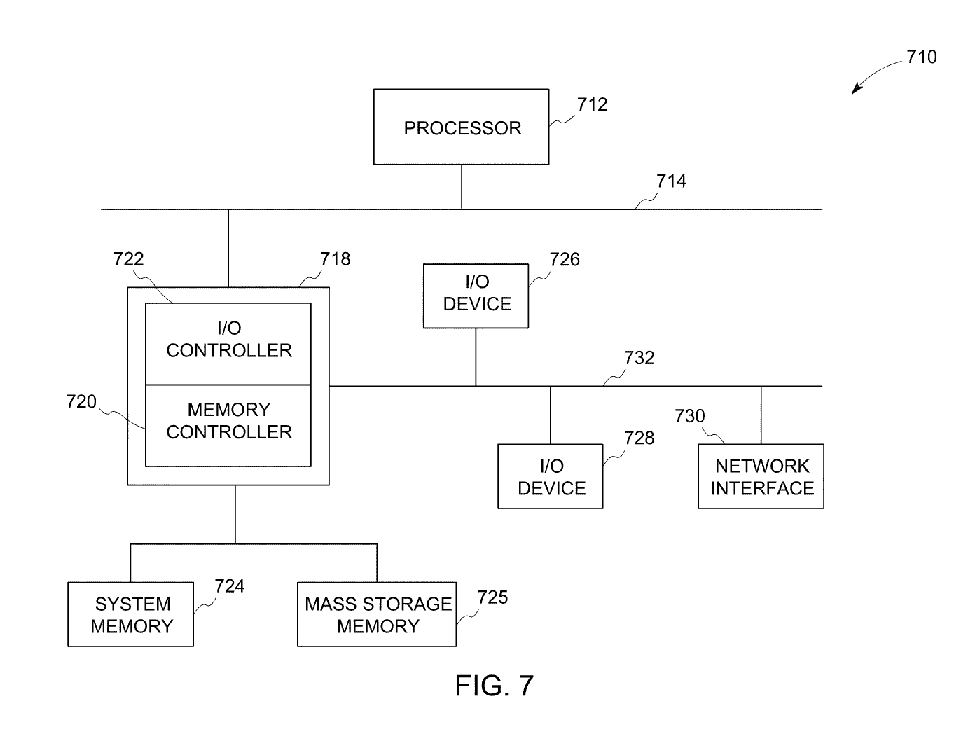

FIG. 7 is a block diagram of an example processor system 710 that may be used to implement systems, apparatus, articles of manufacture, and methods described herein. As shown in FIG. 7, the processor system 710 includes a processor 712 that is coupled to an interconnection bus 714. The processor 712 may be any suitable processor, processing unit, or microprocessor, for example. Although not shown in FIG. 7, the system 710 may be a multi-processor system and, thus, may include one or more additional processors that are identical or similar to the processor 712 and that are communicatively coupled to the interconnection bus 714.

The processor 712 of FIG. 7 is coupled to a chipset 718, which includes a memory controller 720 and an input/output (“I/O”) controller 722. As is well known, a chipset typically provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724 and a mass storage memory 725.

The system memory 724 may include any desired type of volatile and/or non-volatile memory such as, for example, static random access memory (SRAM), dynamic random access memory (DRAM), flash memory, read-only memory (ROM), etc. The mass storage memory 725 may include any desired type of mass storage device including hard disk drives, optical drives, tape storage devices, etc.

The I/O controller 722 performs functions that enable the processor 712 to communicate with peripheral input/output (“I/O”) devices 726 and 728 and a network interface 730 via an I/O bus 732. The I/O devices 726 and 728 may be any desired type of I/O device such as, for example, a keyboard, a video display or monitor, a mouse, etc. The network interface 730 may be, for example, an Ethernet device, an asynchronous transfer mode (“ATM”) device, an 802.11 device, a DSL modem, a cable modem, a cellular modem, etc. that enables the processor system 710 to communicate with another processor system.

While the memory controller 720 and the I/O controller 722 are depicted in FIG. 7 as separate blocks within the chipset 718, the functions performed by these blocks may be integrated within a single semiconductor circuit or may be implemented using two or more separate integrated circuits.

Thus, certain examples provide a tool for patient diagnosis and treatment. Certain examples provide a tool that can be used with a patient's existing cell phone and/or integrated with a similar device. Certain examples provide an ERC focused on removing and/or minimizing obstacles to obtaining a highest available quality of care for a patient. Certain examples can be provided as an add-on to a clinical connectivity framework.

Certain examples contemplate methods, systems and computer program products on any machine-readable media to implement functionality described above. Certain examples can be implemented using an existing computer processor, or by a special purpose computer processor incorporated for this or another purpose or by a hardwired and/or firmware system, for example.

Some or all of the system, apparatus, and/or article of manufacture components described above, or parts thereof, can be implemented using instructions, code, and/or other software and/or firmware, etc. stored on a machine accessible or readable medium and executable by, for example, a processor system (e.g., the example processor system 710 of FIG. 7). When any of the appended claims are read to cover a purely software and/or firmware implementation, at least one of the components is hereby expressly defined to include a tangible medium such as a memory, DVD, CD, etc. storing the software and/or firmware.

FIGS. 1-3 and 5 include data and/or process flow diagrams representative of machine readable and executable instructions or processes that can be executed to implement the example systems, apparatus, and article of manufacture described herein. The example processes of FIGS. 1-3 and 5 can be performed using a processor, a controller and/or any other suitable processing device. For example, the example processes of FIGS. 1-3 and 5 can be implemented in coded instructions stored on a tangible medium such as a flash memory, a read-only memory (ROM) and/or random-access memory (RAM) associated with a processor (e.g., the processor 712 of FIG. 7). Alternatively, some or all of the example processes of FIGS. 1-3 and 5 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 1-3 and 5 can be implemented manually or as any combination(s) of any of the foregoing techniques, for example, any combination of firmware, software, discrete logic and/or hardware. Further, although the example processes of FIGS. 1-3 and 5 are described with reference to the flow diagrams of FIGS. 3 and 5, other methods of implementing the processes of FIGS. 1-3 and 5 can be employed. For example, the order of execution of the blocks may be changed, and/or some of the blocks described may be changed, eliminated, sub-divided, or combined. Additionally, any or all of the example processes of FIGS. 1-3 and 5 can be performed sequentially and/or in parallel by, for example, separate processing threads, processors, devices, discrete logic, circuits, etc.

One or more of the components of the systems and/or blocks of the methods described above may be implemented alone or in combination in hardware, firmware, and/or as a set of instructions in software, for example. Certain examples may be provided as a set of instructions residing on a computer-readable medium, such as a memory, hard disk, DVD, or CD, for execution on a general purpose computer or other processing device. Certain examples may omit one or more of the method blocks and/or perform the blocks in a different order than the order listed. For example, some blocks may not be performed in certain embodiments of the present invention. As a further example, certain blocks may be performed in a different temporal order, including simultaneously, than listed above.

Certain examples include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Examples may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Examples of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments/examples, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An emergency response coordination apparatus, the apparatus comprising:
a memory to store at least patient information, symptom knowledge base information, and care provider information;
a first communication interface to receive symptom information from a patient to be stored in the memory;
a processor to process the received symptom information based on stored patient information, symptom knowledge base information, and care provider information to determine a recommended care plan for the patient and to identify a care provider suitable to treat the patient's symptoms;
a timer to track elapsed time beginning with receipt of symptom information to aid in determining a time window for patient treatment; and
a second communication interface to generate an output of the recommended care plan for the patient and directions to the care provider suitable to treat the patient's symptoms.

2. The apparatus of claim 1, wherein the second communication interface comprises a display to output the recommended care plan for the patient and directions to the care provider suitable to treat the patient's symptoms.

3. The apparatus of claim 1, wherein symptom information is manually entered by a user.

4. The apparatus of claim 1, wherein symptom information is measured by at least one sensor connected with the emergency response coordination device.

5. The apparatus of claim 1, wherein the second communication interface is to deliver information to a mobile phone associated with the patient and allows caregivers access to the patient's electronic medical record during an emergency.

6. The apparatus of claim 1, wherein the processor and the second communication interface are to provide authorization for the care provider to retrieve records via a web browser.

7. The apparatus of claim 1, wherein the processor and the second communication interface are to provide quality information regarding one or more care providers in the vicinity of the patient.

8. The apparatus of claim 1, further comprising a state machine to track events during a time window monitored by the timer and determined based on stored knowledge base information from the memory.

9. The apparatus of claim 1, further comprising a report generator to generate a report including information depending on the patient's current location and nearest suitable care provider.

10. The apparatus of claim 9, wherein the report generator is to summarize and download electronic medical reports to at least one of a mobile phone or other processing device.

11. The apparatus of claim 1, wherein the processor is to interface with a global positioning system to determine patient location.

12. The apparatus of claim 1, wherein the memory receives at least one of patient information, symptom knowledge base information, and care provider information from an external information source.

13. The apparatus of claim 12, wherein the external information source comprises at least one repository or registry organized via a health information exchange.

14. The apparatus of claim 1, wherein the second communication interface is to initiate contact with emergency medical services regarding the patient.

15. The apparatus of claim 1, wherein the second communication interface is to contact an emergency contact associated with the patient.

16. A tangible, computer-readable storage medium including executable program instructions stored on the medium that, when executed by a programmable system, implement an emergency response coordinator comprising:
a patient emergency portal to receive symptom information for a patient;
an emergency case service component to automatically and dynamically coordinate emergency response management for the patient;
a state machine guiding processing of the received symptom information based on stored patient information, symptom knowledge base information, and care provider information to determine a recommended care plan for the patient and to identify, based on the recommended care plan and patient location information, at least one care provider suitable to treat the patient's symptoms;
a timer to track elapsed time beginning with receipt of symptom information to aid in determining a time window for patient treatment; and
a notification broker to generate an output of the recommended care plan for the patient and directions to the care provider suitable to treat the patient's symptoms.

17. The computer-readable storage medium of claim 16, wherein the notification broker is to deliver information to a mobile device associated with the patient and allows a care provider to access to the patient's electronic medical record.

18. The computer-readable storage medium of claim 16, further comprising a report generator to generate a report including information depending on the patient's current location and nearest suitable care provider.

19. The computer-readable storage medium of claim 16, further comprising an interface to exchange information regarding the patient with a health information exchange infrastructure including at least one data repository or registry.

20. The computer-readable storage medium of claim 16, wherein the notification broker is to initiate contact with a care provider regarding the patient.

21. A method of patient-initiated emergency response coordination, the method comprising:
receiving, via a mobile device, an activation of emergency response from a user;
generating, based on user medical history and symptom information, patient location information, and care provider information, directions to a nearest suitable care provider for the user and providing the directions to the user via the mobile device;
notifying the nearest suitable care provider of the condition of the patient and the patient's impending arrival;
tracking elapsed time from the activation of the emergency response and providing the elapsed time to the care provider; and
outputting patient information to the care provider to facilitate patient admission and treatment.

22. The method of claim 21, further comprising transferring patient information to a health information exchange to update a patient electronic record.

23. The method of claim 21, further comprising relaying information to emergency medical services responding to the patient.

24. The method of claim 21, further comprising notifying at least one of an emergency contact and a primary care provider regarding patient admission to a care provider.

25. The method of claim 21, further comprising initiating a teleconsultation with trained medical personnel to guide at least one of the patient and a bystander regarding treatment of the patient.

26. The method of claim 21, further comprising storing an audit log regarding care given and instructions provided.
